(19) United States
(12) Patent Application Publication
(10) Pub. No.: US 2022/0221127 A1
(43) Pub. Date: Jul. 14, 2022

(54) ORIGAMI LAMP AND PLANAR BENDABLE SHEET FOR BEING FORMED INTO THE ORIGAMI LAMP

(71) Applicant: Robert J. LANG, Altadena, CA (US)

(72) Inventor: Robert J. LANG, Altadena, CA (US)

(21) Appl. No.: 17/607,730

(22) PCT Filed: Apr. 30, 2020
(86) PCT No.: PCT/US20/30701

§ 371 Date: Oct. 29, 2021

Related U.S. Application Data
(60) Provisional application No. 62/841,802, filed on May 1, 2019.

(51) Int. Cl. F21V 1/14; F21V 21/06; F21V 19/00

(52) U.S. Cl. CPC F21V 1/146; F21Y 2115/10; F21V 19/003; F21V 21/06

(57) ABSTRACT

An origami lamp includes a lamp stand having a standing portion and a connecting portion, a light emitter provided with a light source, and a lampshade, which are connected integrally. By bending and fastening a planar bendable sheet, a bottom section, a lower part and an upper part of a middle section and a top section of the planar bendable sheet are respectively formed into the standing portion as a tube, the connecting portion as a cone, the light emitter as another cone and the lampshade as a cloak at the same time. As a result, the origami lamp is easily formed from the planar bendable sheet, so the planar bendable sheet can serve as the product for sale for the convenience in storage and transportation.

### BACKGROUND OF THE INVENTION

### 1. Field of the Invention

The present invention relates generally to lamps and more particularly, to an origami lamp and a planar bendable sheet, wherein the origami lamp is formed from the planar bendable sheet.

### 2. Description of the Related Art

The conventional desk lamp usually includes a lamp stand made of wood, plastics or metal, a light source such as a bulb disposed on the lamp stand, and a lampshade disposed on the lamp stand to cover the light source and diffuse the light thereof. Such configuration brings the conventional desk lamp a stereoscopic shape for suitably used on the desk, but also causes the conventional desk lamp to occupy too much space in storage and transportation.

The conventional origami lamp uses an origami lampshade formed from folded papers, that is usually not designed for the consumer to form the folded papers into the origami lampshade, but already formed when being a product. Such lamp is also inconvenient in storage and transportation, and even needs to be stored and transported with more care.

### SUMMARY OF THE INVENTION

The present invention has been accomplished in view of the above-noted circumstances. It is an objective of the present invention to provide an origami lamp, which is easily formed from a planar bendable sheet, so the planar bendable sheet can serve as the product for sale for the convenience in storage and transportation.

To attain the above objective, the present invention provides an origami lamp which is formed from a planar bendable sheet and includes a lamp stand, a light emitter and a lampshade. The lamp stand has a standing portion and a connecting portion integrally connected with the standing portion. The light emitter is provided with a light source and integrally connected with the connecting portion of the lamp stand. The lampshade is integrally connected with the light emitter and the standing portion of the lamp stand.

Preferably, the standing portion is shaped as a tube and has two lateral edges connected with each other. The connecting portion is inwardly recessed from a top of the standing portion in a way that the connecting portion has a cone shape, a main point and two edges extending from the main point and being connected with each other. The light emitter upwardly extends from the main point of the connecting portion in a way that the light emitter has a cone shape and two edges connected with each other. The lampshade is shaped as a cloak extending from a top of the light emitter outwardly and downwardly and having two lateral edges connected with each other.

To attain the above objective, the present invention provides a planar bendable sheet for being formed into the aforesaid origami lamp. The planar bendable sheet includes an annular fold line and a middle section defined by the annular fold line. The middle section has a main point and two inner radial fold lines extending from the main point to the annular fold line. The two inner radial fold lines divide the middle section into a lower part and an upper part provided with the light source for being formed into the connecting portion of the lamp stand and the light emitter of the origami lamp respectively.

Preferably, two junctions of the annular fold line and the two inner radial fold lines divide the annular fold line into a lower segment and an upper segment, and the planar bendable sheet further includes a circumference, two outer radial fold lines, a bottom section and a top section. The circumference includes a lower curve, an upper curve and two junctions of the lower curve and the upper curve. The two outer radial fold lines extend from the two junctions of the annular fold line and the two inner radial fold lines to the two junctions of the circumference. The bottom section is defined by the lower segment of the annular fold line, the lower curve of the circumference and the two outer radial fold lines for being formed into the standing portion of the lamp stand of the origami lamp. The top section is defined by the upper segment of the annular fold line, the upper curve of the circumference and the two outer radial fold lines for being formed into the lampshade of the origami lamp.

As a result, the planar bendable sheet can be easily formed into the origami lamp by an act of bending the planar bendable sheet and fastening means such as fastening the two lateral edges of the standing portion (i.e. two lateral edges of the bottom section of the planar bendable sheet) with a clip, so that the origami lamp has a stereoscopic shape for suitably used on a plane such as a desktop. Therefore, the planar bendable sheet can serve as the product for sale, and the consumer can form the planar bendable sheet into the origami lamp easily. In other words, it is convenient to store and transport the product of the present invention in the form of a planar sheet.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIGS. 1 and 2 are front and back views of a planar bendable sheet according to a preferred embodiment of the present invention;

FIG. 3 is a sectional view taken along the line 3-3 in FIG. 2;

FIG. 4 is similar to FIG. 2, but showing a different type of power cord connection; and

FIGS. 5-8 are front, back, side and top views of an origami lamp according to the preferred embodiment of the present invention.

### DETAILED DESCRIPTION OF THE INVENTION

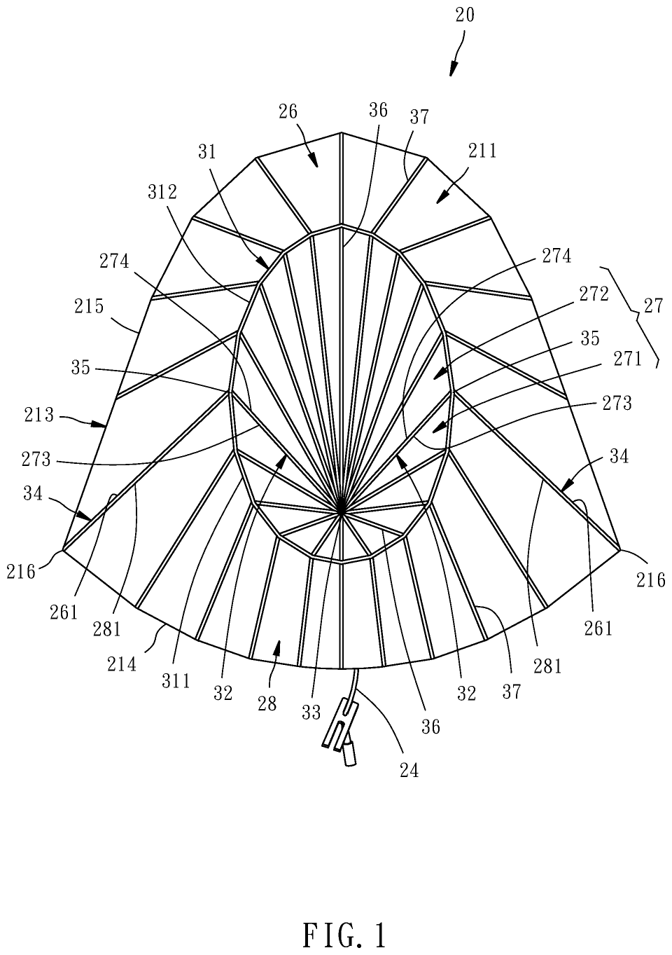

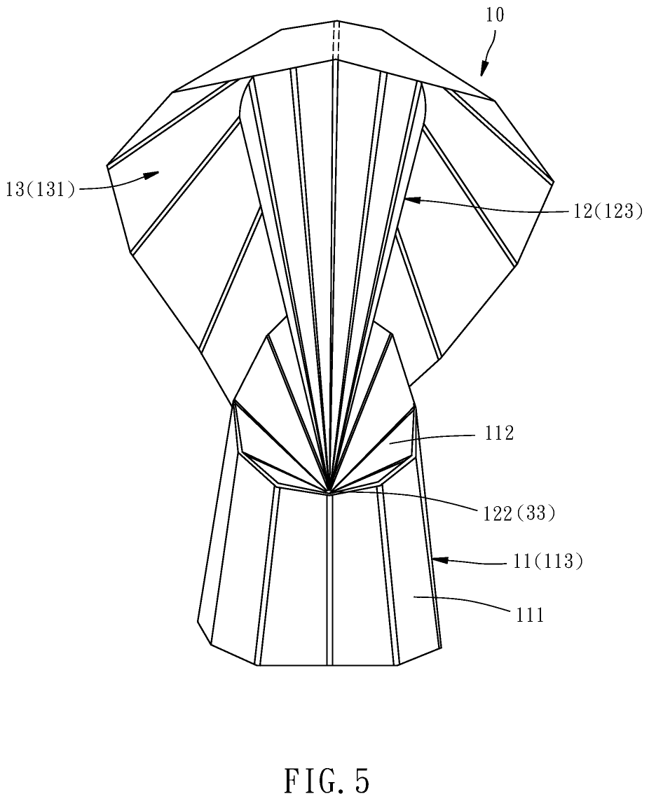

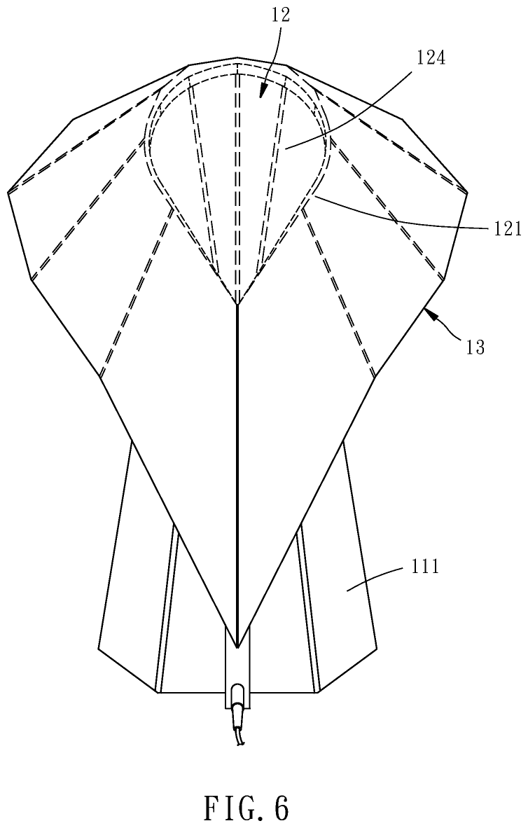

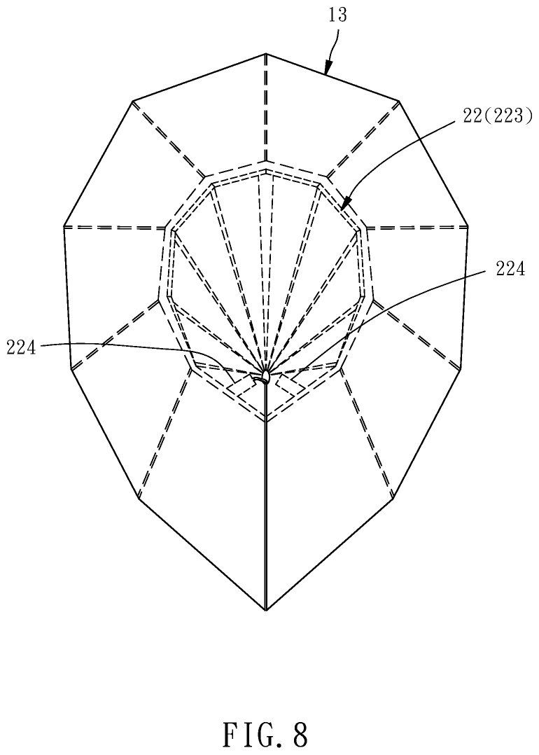

Referring to FIGS. 1-8, an origami lamp 10 as shown in FIGS. 5-8 is formed from a planar bendable sheet 20 as shown in FIGS. 1-4.

Referring to FIGS. 1-3, the planar bendable sheet 20 primarily includes a translucent sheet body 21, a light source 22, and a translucent cover 23.

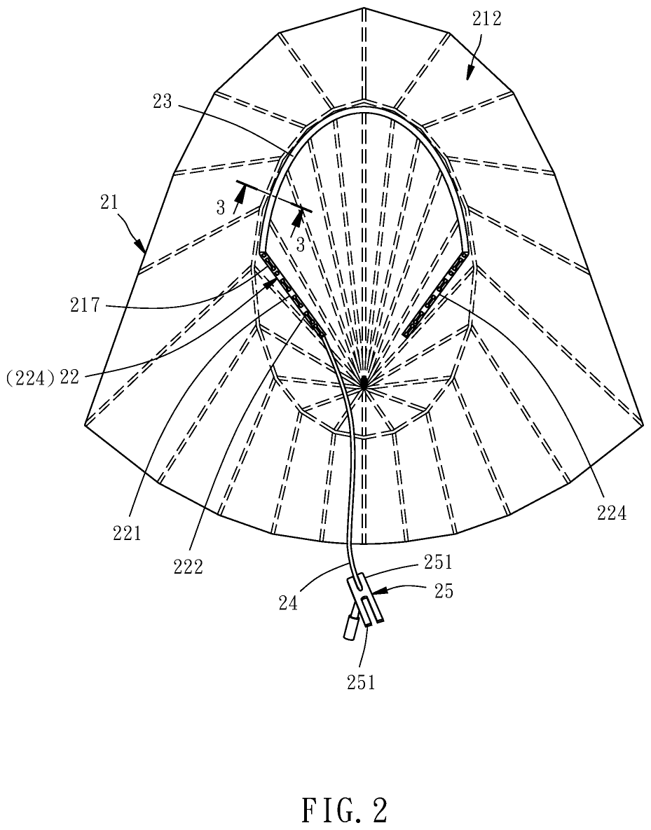

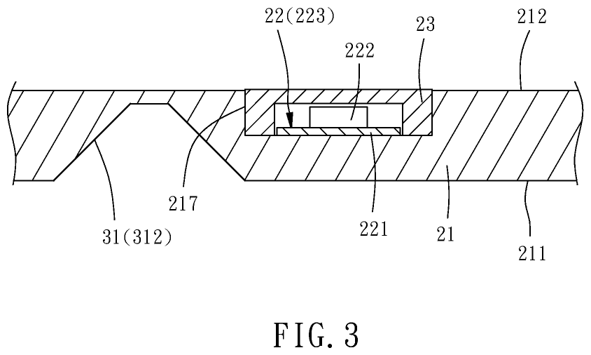

The translucent sheet body 21 is a translucent plastic sheet made of, but not limited to, polypropylene (PP), which has a front surface 211 as shown in FIG. 1, and a back surface 212 as shown in FIG. 2. The translucent sheet body 21 is manufactured with a specific outline in a way that the circumference 213 of the translucent sheet body 21 consists of a lower curve 214 with multiple relatively larger radiuses of curvature, an upper curve 215 with multiple relatively smaller radiuses of curvature, and two junctions 216 of the lower curve 214 and the upper curve 215. In addition, the translucent sheet body 21 is manufactured with many grooves recessed from the front surface 211, that will be specified hereunder, and a light installation groove 217 recessed from the back surface 212 as shown in FIGS. 2 and 3. It is to be mentioned, the so-called “curves”, e.g. lower and upper curves 214 and 215, are actually realized by piecewise continuous straight lines in this embodiment. However, in another embodiment, they are realized by continuous smooth curves. In other words, a curved edge or curved fold may be realized as a smooth curve or as a series of straight segments approximating a curved line, as is shown in this embodiment.

The light source 22 is an LED (light emitting diode) light strip including a flexible printed circuit (FPC) 221 made of, but not limited to, glass fiber and copper foil, and a plurality of LED light beads 222, thereby shaped as a planar flexible elongated strip. The LED light strip 22 is embedded in the light installation groove 217. The cover 23, which is also made of plastics such as polypropylene (PP), is also embedded in the light installation groove 217 and covers the LED light strip 22. The cover 23 is fixed in the light installation groove 217 by ultrasonic welding, or may be fixed there by gluing. The planar bendable sheet 20 further includes a power cord 24 electrically connected with the LED light strip 22, and a clip 25 disposed on the power cord 24, that will be specified hereunder.

Referring to FIG. 1, the grooves on the front surface 211 primarily includes an annular fold line 31, two inner radial fold lines 32 extending from a main point 33 to the annular fold line 31, and two outer radial fold lines 34 extending from two junctions 35 of the annular fold line 31 and the two inner radial fold lines 32 to the two junctions 216 of the circumference 213. The two junctions 35 divide the annular fold line 31 into a lower segment 311 and an upper segment 312. The annular fold line 31 and the two outer radial fold lines 34 divide the planar bendable sheet 20 into top, middle and bottom sections 26, 27 and 28. Specifically speaking, the middle section 27 is defined by the annular fold line 31; the bottom section 28 is defined by the lower segment 311 of the annular fold line 31, the lower curve 214 of the circumference 213 and the two outer radial fold lines 34; the top section 26 is defined by the upper segment 312 of the annular fold line 31, the upper curve 215 of the circumference 213 and the two outer radial fold lines 34. The two inner radial fold lines 32 divide the middle section 27 into a lower part 271 and an upper part 272, wherein the light source 22 is provided in the upper part 272. Referring to FIGS. 2-3, the LED light strip 22 includes a section 223, namely a central section, located along the upper segment 312 of the annular fold line 31, and two other sections 224, namely lateral sections, extending from two ends of the section 223 toward the main point 33 along the two inner radial fold lines 32 respectively.

Referring to FIG. 1, the grooves on the front surface 211 further includes a plurality of inner radial grooves 36 provided in the lower part 271 and the upper part 272 of the middle section 27 and extending from the main point 33 to the annular fold line 31 radially, and a plurality of outer radial grooves 37 provided in the bottom section 28 and the top section 26 and extending from the annular fold line 31 to the circumference 213 radially.

The above-described planar bendable sheet 20 as shown in FIGS. 1-3 can be formed into the origami lamp 10 as shown in FIGS. 5-8 by an act of bending the planar bendable sheet 20 and fastening means. Referring to FIGS. 5-8, the origami lamp 10 includes a lamp stand 11 having a standing portion 111 and a connecting portion 112 integrally connected with the standing portion 111, a light emitter 12 integrally connected with the connecting portion 112 of the lamp stand 11, and a lampshade 13 integrally connected with the light emitter 12 and the standing portion 111 of the lamp stand 11. The standing portion 111 of the lamp stand 11 is shaped as a tapered tube from the bottom section 28 of the planar bendable sheet 20 by the aforesaid act and fastening means in a way that two lateral edges 281 of the bottom section 28 are connected or abutted with each other. In other words, the standing portion 111 of the lamp stand 11 has two lateral edges connected or abutted with each other. The connecting portion 112 is a concaved recess shaped as a cone extending from the top of the standing portion 111 thereinto, which is formed from the lower part 271 of the middle section 27 of the planar bendable sheet 20 by the aforesaid act and fastening means in a way that two radial edges 273 of the lower part 271 extending from the main point 33 are connected or abutted with each other. In other words, the connecting portion 112 is inwardly recessed from the top of the standing portion 111 in a way that the connecting portion 112 has a cone shape, a main point 33 and two edges extending from the main point 33 and being connected or abutted with each other. The light emitter 12 is shaped as another cone extending from the connecting portion 112 upwardly, which is formed from the upper part 272 of the middle section 27 of the planar bendable sheet 20 by the aforesaid act and fastening means in a way that two radial edges 274 of the upper part 272 extending from the main point 33 are connected or abutted with each other. In other words, the light emitter 12 upwardly and expandly extends from the main point 33 of the connecting portion 112 in a way that the light emitter 12 has a cone shape and two edges connected or abutted with each other. The lampshade 13 is shaped as a cloak extending from the top of the light emitter 12 outwardly and downwardly, which is formed from the top section 26 of the planar bendable sheet 20 by the aforesaid act and fastening means in a way that two lateral edges 261 of the top section 26 are connected or abutted with each other. In other words, the lampshade 13 has two lateral edges connected or abutted with each other.

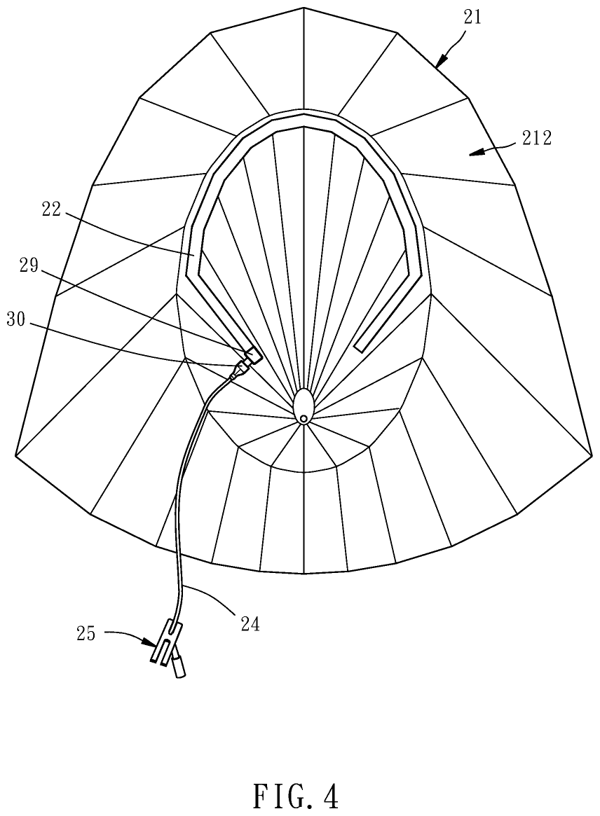

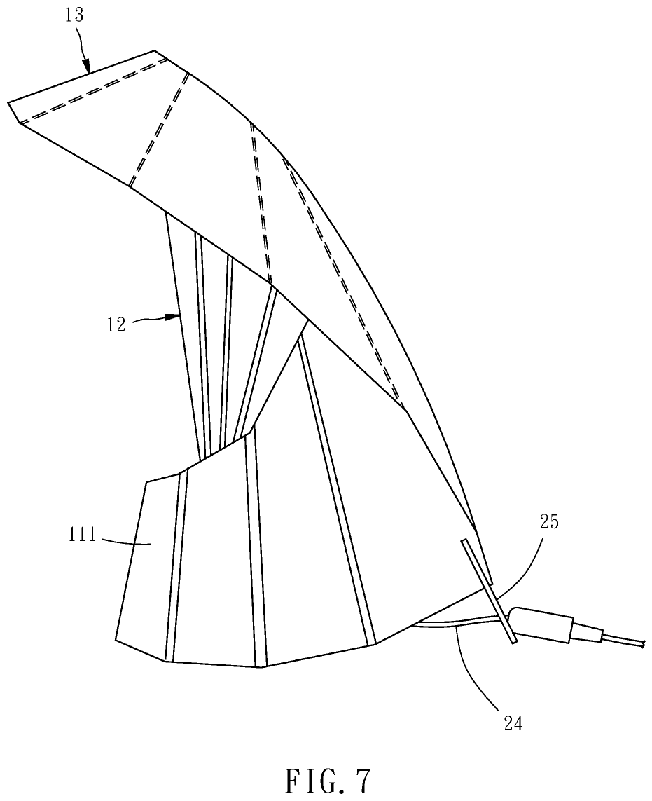

The aforesaid fastening means may be realized in this embodiment by fastening the two lateral edges 281 of the bottom section 28 of the planar bendable sheet 20 with the clip 25. Specifically speaking, the clip 25 is provided at each end thereof with two feet 251, as shown in FIG. 2; the power cord 24 is clipped between the two feet 251 of an end of the clip 25; the two lateral edges 281 of the bottom section 28 is clipped between the two feet 251 of the other end of the clip 25. Through the fastening means, the origami lamp 10 formed from the planar bendable sheet 20 is kept in the stereoscopic status. Besides, the two feet 251 for clipping the power cord 24 is adapted for standing on a plane such as a desktop along with the lamp stand 11, as shown in FIG. 7. It is to be understood that any fastening member, such as snap on button, loop and hook fastener, needle, pin, etc., that can hold two lateral edges 281 of the bottom section 28 of the planar bendable sheet 20 can be used in the present invention. Further, as shown in FIG. 4, the power cord 24 may be detachably connected with the LED light strip 22 through a pair of USB connectors 29 and 30. Specifically speaking, the USB connector 29 is fixed at an end of the LED light strip 22, and the USB connector 30 is fixed at an end of the power cord 24, so that the power cord 24 can be connected with the LED light strip 22 or detached therefrom.

When the origami lamp 10 is turned on, light is emitted from the LED light strip 22 provided in the light emitter 12. The central section 223 of the LED light strip 22 is located along the opening 121 at the top of the light emitter 12, therefore the top of the light emitter 12 is relatively brighter and emits much light toward the lampshade 13. Besides, the lateral sections 224 of the LED light strip 22 extend from the central section 223 toward the apex 122 at the bottom of the light emitter 12, therefore the light from the lateral sections 224 is centralized at the bottom of the light emitter 12. Because the front surface 211 of the planar bendable sheet 20 is formed into the external surface 113 of the lamp stand 11, the external surface 123 of the light emitter 12 and the internal surface 131 of the lampshade 13, the power cord 24 connected with the LED light strip 22 extends from the internal surface 124 of the light emitter 12 and mostly hidden inside and under the lamp stand 11.

As a result, the planar bendable sheet 20 can be easily formed into the origami lamp 10 by the act of bending the planar bendable sheet 20 and the fastening means realized by using the clip 25 in this embodiment, so that the origami lamp 10 has the stereoscopic shape for suitably used on the desk. Therefore, the planar bendable sheet 20 can serve as the product for sale, and the consumer can form the planar bendable sheet 20 into the origami lamp 10 easily. In other words, it is convenient to store and transport the product of the present invention in the form of a planar sheet.

What is claimed is:

1. An origami lamp formed from a planar bendable sheet, the origami lamp comprising:
a lamp stand having a standing portion and a connecting portion integrally connected with the standing portion;
a light emitter provided with a light source and integrally connected with the connecting portion of the lamp stand; and
a lampshade integrally connected with the light emitter and the standing portion of the lamp stand.

2. The origami lamp as claimed in claim 1, wherein the connecting portion of the lamp stand comprises a concaved recess having a main point; the light emitter has a cone shape extending from the main point of the connecting portion upwardly; the lampshade extends from a top of the light emitter outwardly and downwardly.

3. The origami lamp as claimed in claim 1, wherein:
the standing portion of the lamp stand is shaped as a tube and has two lateral edges connected with each other;
the connecting portion is inwardly recessed from a top of the standing portion in a way that the connecting portion has a cone shape, a main point and two edges extending from the main point and being connected with each other;
the light emitter upwardly extends from the main point of the connecting portion in a way that the light emitter has a cone shape and two edges connected with each other; and
the lampshade is shaped as a cloak extending from a top of the light emitter outwardly and downwardly and having two lateral edges connected with each other.

4. The origami lamp as claimed in claim 3, wherein the origami lamp comprises a power cord electrically connected with the light source, and a clip disposed on the power cord; the clip is fastened to the two lateral edges of the standing portion.

5. The origami lamp as claimed in claim 4, wherein the clip has two feet adapted for standing on a plane along with the lamp stand, and the power cord is clipped between the two feet.

6. The origami lamp as claimed in claim 1, wherein the light emitter is provided at a top and a bottom thereof with an opening and an apex, and the light source is an LED light strip which comprises a central section located along the opening.

7. The origami lamp as claimed in claim 6, wherein the LED light strip comprises a lateral section extending from the central section.

8. A planar bendable sheet for being formed into the origami lamp as claimed in claim 1, the planar bendable sheet comprising:
an annular fold line and a middle section defined by the annular fold line, the middle section having a main point and two inner radial fold lines extending from the main point to the annular fold line, the two inner radial fold lines dividing the middle section into a lower part and an upper part provided with the light source for being formed into the connecting portion of the lamp stand and the light emitter of the origami lamp respectively.

9. The planar bendable sheet as claimed in claim 8, wherein two junctions of the annular fold line and the two inner radial fold lines divide the annular fold line into a lower segment and an upper segment; the planar bendable sheet further comprises:
a circumference comprising a lower curve, an upper curve and two junctions of the lower curve and the upper curve;
two outer radial fold lines extending from the two junctions of the annular fold line and the two inner radial fold lines to the two junctions of the circumference;
a bottom section defined by the lower segment of the annular fold line, the lower curve of the circumference and the two outer radial fold lines for being formed into the standing portion of the lamp stand of the origami lamp; and
a top section defined by the upper segment of the annular fold line, the upper curve of the circumference and the two outer radial fold lines for being formed into the lampshade of the origami lamp.

10. The planar bendable sheet as claimed in claim 9, wherein the planar bendable sheet has a front surface and a back surface; the front surface is formed into an external surface of the lamp stand, an external surface of the light emitter and an internal surface of the lampshade.

11. The planar bendable sheet as claimed in claim 10, wherein the annular fold line, the inner radial fold lines and the outer radial fold lines are shaped as grooves recessed from the front surface.

12. The planar bendable sheet as claimed in claim 11, wherein each of the lower part and the upper part of the middle section has a plurality of inner radial grooves recessed from the front surface and extending from the main point to the annular fold line; each of the bottom section and the top section has a plurality of outer radial grooves recessed from the front surface and extending from the annular fold line to the circumference.

13. The planar bendable sheet as claimed in claim 10, wherein the planar bendable sheet comprises a translucent sheet body having the front surface, the back surface and a light installation groove recessed from the back surface, and the light source is an LED light strip embedded in the light installation groove.

14. The planar bendable sheet as claimed in claim 13, wherein the planar bendable sheet comprises a cover embedded in the light installation groove and covering the LED light strip.

15. The planar bendable sheet as claimed in claim 9, wherein the light source is an LED light strip which comprises a central section located along the upper segment of the annular fold line.

16. The planar bendable sheet as claimed in claim 15, wherein the LED light strip comprises two lateral sections extending along the two inner radial fold lines respectively.
